(19) United States
(12) Patent Application Publication
(10) Pub. No.: US 2021/0122671 A1
(43) Pub. Date: Apr. 29, 2021

(54) HARD ANTI-REFLECTIVE COATINGS

(71) Applicant: Corning Incorporated, Corning, NY (US)

(72) Inventors: Shandon Dee Hart, Elmira, NY (US); Karl William Koch, III, Elmira, NY (US); Charles Andrew Paulson, Painted Post, NY (US)

(21) Appl. No.: 16/635,684

(22) PCT Filed: Jul. 30, 2018
(86) PCT No.: PCT/US2018/044401

§ 371 Date: Jan. 31, 2020

Related U.S. Application Data
(60) Provisional application No. 62/539,260, filed on Jul. 31, 2017.

(51) Int. Cl. C03C 17/34; G02B 1/115; G02B 1/14

(52) U.S. Cl. CPC C03C 17/3441; C03C 2217/734; G02B 1/14; G02B 1/115

(57) ABSTRACT

An article includes a substrate including a glass, glass-ceramic, or ceramic composition and a primary surface. An optical film is disposed on the primary surface. The film includes a first plurality of layers which includes diamond or diamond-like carbon and a second plurality of layers. Each layer of the second plurality of layers is arranged in an alternating manner with each layer of the first plurality of layers. The optical film includes an average photopic light reflectance of about 2.0% or less and a transmittance of about 85% or greater from about 500 nm to about 800 nm.

### CROSS-REFERENCE TO RELATED APPLICATION

This application claims the benefit of priority under 35 U.S.C. § 119 of U.S. Provisional Application Ser. No. 62/539,260 filed on Jul. 31, 2017, the content of which is relied upon and incorporated herein by reference in its entirety.

### FIELD OF THE DISCLOSURE

The disclosure relates to articles with scratch-resistant anti-reflective coatings, and more particularly to articles that exhibit a high hardness and low reflective color shift when viewed at different incident illumination angles.

### BACKGROUND

Anti-reflection (AR) coatings are common in many applications. Front covers for consumer electronics and display devices such as smartphones present special challenges for anti-reflection coatings. In particular, the color and durability against damage requirements such as fine scratches are much higher in a smartphone cover glass application than in other applications of AR coatings. Color changes with viewing angle can result in a display appearance that is unacceptable to viewers, and small scratches or abrasions can degrade the readability and cosmetic appeal of modern high-resolution displays. Durable anti-reflection coating materials and optical designs are desirable for enabling outdoor readability of modern displays while maintaining good scratch resistance and film integrity through a variety of abuses that consumers may inflict on their smartphones or other display devices.

Increasing hardness is one way to improve the scratch resistance and durability of hardcoating materials. Diamond, diamond-like carbon (DLC) and diamond coatings are among the hardest materials, and in many cases have other desirable properties such as low coefficient of friction. However, diamond coating materials typically have high optical absorption (particularly in visible and especially in blue wavelengths) that creates substantial color in the coated articles, thereby making them unacceptable for demanding applications such as smartphone displays. Thus, the thickness of diamond or diamond films in these applications is typically limited to less than 5 nm due to the optical absorption of the diamond film. Fluorinated DLC films can overcome this problem and generate good color in AR coatings having a DLC protective layer, but such thin diamond coatings act primarily as a lubricious layer and provide little protection against typical consumer-induced scratches that frequently have depths in the 100 nm-500 nm range. By limiting the thickness of conventional diamond coatings to less than 5 nm, the hardness of the diamond coating is of minimal benefit in protecting against typical scratches. A secondary limitation of common anti-reflection coatings is the need for at least one constituent of the structure to be a material having a low refractive index, such as SiO₂ or MgF₂. Such materials have a relatively low hardness compared to desirable hardcoating materials, and are easily scratched by common everyday materials such as sand.

Accordingly, there is a need for articles that exhibit a high hardness, low reflectance, and low reflective color shift when viewed at different incident illumination angles.

### SUMMARY OF THE DISCLOSURE

According to some aspects of the present disclosure, an article includes a glass-based substrate comprising a primary surface. An optical film is disposed on the primary surface. The film includes a first plurality of layers which includes one or more of diamond, a diamond film, diamond-containing material, diamond-like carbon and amorphous carbon and a second plurality of layers. Each layer of the second plurality of layers is arranged in an alternating manner with each layer of the first plurality of layers. The optical film includes a single-surface average photopic light reflectance of about 2.0% or less and a transmittance of about 85% or greater over the wavelength range of from about 500 nm to about 800 nm.

According to some aspects of the present disclosure, an article includes a substrate including a glass, glass-ceramic, or ceramic composition and a primary surface. An optical film is disposed on the primary surface. The optical film includes a first plurality of layers which include diamond or diamond-like carbon and a second plurality of layers. Each layer of the second plurality of layers is arranged in an alternating manner with each layer of the first plurality of layers. The optical film includes a single-surface average photopic light reflectance of about 2.0% or less and a transmittance of about 85% or greater from about 500 nm to about 800 nm. Greater than 50% of the layers of the first and second plurality of layers each have a refractive index of about 1.6 or greater at 550 nm wavelength.

According to some aspects of the present disclosure, a consumer electronic product includes a housing having a front surface, a back surface and side surfaces and electrical components partially within the housing, the electrical components include one or more of a controller, a memory, and a display. The display is at or adjacent to the front surface of the housing and a cover glass is disposed over the display. One or more of a portion of the housing or the cover glass includes the glass-based article as described herein.

According to yet another aspect of the present disclosure, a method of forming an optical film is provided which includes the steps: depositing a plurality of first layer layers comprising diamond or diamond-like carbon on a primary surface of a glass-based substrate; and depositing a second plurality of layers arranged in an alternating manner with each layer of the first plurality of layers such that the optical film comprises an average photopic light reflection of about 2.0% or less and a transmittance of about 85% or greater over the wavelength range of from about 500 nm to about 800 nm.

These and other aspects, objects, and features of the present disclosure will be understood and appreciated by those skilled in the art upon studying the following specification, claims, and appended drawings.

According to a first aspect, an article is provided that includes a glass-based substrate comprising a primary surface, and an optical film disposed on the primary surface. The optical film comprises a first plurality of layers which includes one or more of diamond, a diamond film, diamond-containing material, diamond-like carbon and amorphous carbon and a second plurality of layers. Each layer of the second plurality of layers arranged in an alternating manner with each layer of the first plurality of layers. The optical film comprises an average photopic light reflection of about 2.0% or less and a transmittance of about 85% or greater over the wavelength range of from about 500 nm to about 800 nm.

According to a second aspect, the article of aspect 1 is provided, wherein one or more layers of the first plurality of layers comprises a thickness of about 50 nm or greater.

According to a third aspect, the article of aspects 1 or 2 is provided, wherein the first plurality of layers comprises a total thickness of about 30% or greater of a total thickness of the optical film.

According to a fourth aspect, the article of aspects 1 or 2 is provided, wherein the first plurality of layers comprises a total thickness of about 40% or greater of a total thickness of the optical film.

According to a fifth aspect, the article of any of aspects 1-4 is provided, wherein one or more layers of the second plurality of layers comprises a thickness of about 10 nm or greater and comprises one or more of Al₂O₃, SiO₂, SiOₓN_{y}, SiN_{X} and SiAlON.

According to a sixth aspect, the article of any of aspects 1-5 is provided and further comprises a seed layer positioned between one or more of the first and second layers, wherein the seed layer comprises a diamond-nucleating material.

According to a seventh aspect, the article of aspect 6 is provided, wherein the seed layer comprises a thickness between about 1 nm and about 10 nm.

According to an eighth aspect, the article of any of aspects 1-7 is provided, wherein an sp3/sp2 bond ratio of each layer of the first plurality of layers is about 50% or greater.

According to a ninth aspect, the article of any one of aspects 1-8 is provided, wherein a total number of the layers of the first and second plurality of layers is about 20 or less.

According to a tenth aspect, the article of any one of aspects 1-9 is provided, wherein each layer of the second plurality of layers comprises a refractive index of about 1.45 or greater at a wavelength of 550 nm.

According to an eleventh aspect, the article of aspect 10 is provided, wherein each layer of the first plurality of layers comprises a refractive index of about 2.0 or greater at a wavelength of 550 nm.

According to a twelfth aspect, the article of any one of aspects 1-11 is provided, wherein the optical film comprises a single-surface average photopic light reflection of about 0.5% or less.

According to a thirteenth aspect, the article of any one of aspects 1-12 is provided, wherein the article comprises or is characterized by a color shift of about 5 or less, when viewed at an incident illumination angle in the range from about 20 degrees to about 60 degrees from normal incidence, wherein the color shift is given by √((a*₂−a_{*1})²+(b*₂−b*₁)²), where a*₁ and b*₁ are color coordinates of the article when viewed at normal incidence and a*₂, and b*₂ are color coordinates of the article viewed at the incident illumination angle, and further wherein the color coordinates of the article when viewed at normal incidence and at the incident illumination angle are both in transmission or reflection.

According to a fourteenth aspect, an article is provided which includes a substrate comprising a glass, glass-ceramic, or ceramic composition and a primary surface. An optical film is disposed on the primary surface and includes a first plurality of layers comprising diamond or diamond-like carbon, and a second plurality of layers. Each layer of the second plurality of layers is arranged in an alternating manner with each layer of the first plurality of layers. The optical film comprises an average photopic light reflection of about 2.0% or less and a transmittance of about 85% or greater from about 500 nm to about 800 nm. Greater than 50% of the layers of the first and second plurality of layers each comprises a refractive index of about 1.6 or greater at 550 nm wavelength.

According to a fifteenth aspect, the article of aspect 14 is provided, wherein the optical film comprises a photopic transmittance of about 90% or greater.

According to a sixteenth aspect, the article of either of aspects 14 and 15 is provided, wherein the substrate comprises a glass selected from the group consisting of soda lime glass, alkali aluminosilicate glass, alkali containing borosilicate glass and alkali aluminoborosilicate glass.

According to a seventeenth aspect, the article of any one of aspects 14-16, wherein the article comprises or is characterized by a color shift of about 5 or less, when viewed at an incident illumination angle in the range from about 20 degrees to about 60 degrees from normal incidence, wherein the color shift is given by √/((a*₂−a*₁)²+(b*₂−b*₁)²), where a*₁ and b*₁ are color coordinates of the article when viewed at normal incidence and a*₂, and b*₂ are color coordinates of the article viewed at the incident illumination angle, and further wherein the color coordinates of the article when viewed at normal incidence and at the incident illumination angle are both in transmission or reflection.

According to an eighteenth aspect, the article of any one of aspects 14-17 is provided, wherein each layer of the second plurality of layers comprises a refractive index of about 1.6 or greater at a wavelength of 550 nm.

According to a nineteenth aspect, the article of aspect 18 is provided, wherein each layer of the first plurality of layers comprises a refractive index of about 2.0 or greater at a wavelength of 550 nm.

According to a twentieth aspect, a consumer electronic product is provided including a housing having a front surface, a back surface and side surfaces. Electrical components are partially within the housing. The electrical components comprise one or more of a controller, a memory, and a display, the display at or adjacent the front surface of the housing. A cover glass is disposed over the display. At least one or more of a portion of the housing or the cover glass comprises the article of any one of claims 1-19.

According to a twenty-first aspect, a method of forming an optical film is provided which includes the steps: depositing a plurality of first layer layers comprising diamond or diamond-like carbon on a primary surface of a glass-based substrate; and depositing a second plurality of layers arranged in an alternating manner with each layer of the first plurality of layers such that the optical film comprises an average photopic light reflection of about 2.0% or less and a transmittance of about 85% or greater over the wavelength range of from about 500 nm to about 800 nm.

According to a twenty-second aspect, the method of aspect 21 is provided, further comprising the step of depositing a seed layer further comprising a diamond nucleating material positioned between one or more of the first and second layers.

According to a twenty-third aspect, the method of either aspects 21 and 22 is provided, wherein the step of depositing the first plurality of layers further comprises depositing the first plurality of layers such that a total thickness of about 40% or greater of a total thickness of the optical film comprises the first plurality of layers.

According to a twenty-fourth aspect, the method of any one of aspects 21-23 is provided, wherein the step of depositing the second plurality of layers further comprises depositing one or more of the second plurality of layers at a thickness of about 10 nm or greater.

According to a twenty-fifth aspect, the method of any of aspects 21-24 is provided, wherein the step of depositing the first plurality of layers further comprises depositing the first plurality of layers such that a sp3/sp2 bond ratio of each layer of the first plurality of layers is about 50% or greater.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a cross-sectional view of an article including a film, according to at least one example;

FIG. 2 is a schematic view of a consumer electronic product, according to at least one example;

FIG. 3 is a plot of modeled first surface reflectance for a variety of examples of the present disclosure;

FIG. 4 is a plot of first surface reflected color and two surface transmitted color for a variety of examples of the present disclosure;

FIG. 5 is a plot of first surface transmittance for a variety of examples of the present disclosure;

FIG. 6 is a graph of first surface photopic average reflectance of Examples 1-3;

FIG. 7 is a graph of two surface photopic average transmittance of Examples 1-3; and

FIG. 8 is a plot of hardness versus indentation depth for various thicknesses of film on a substrate.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, up, down, left, right, front, back, and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally or monolithically formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

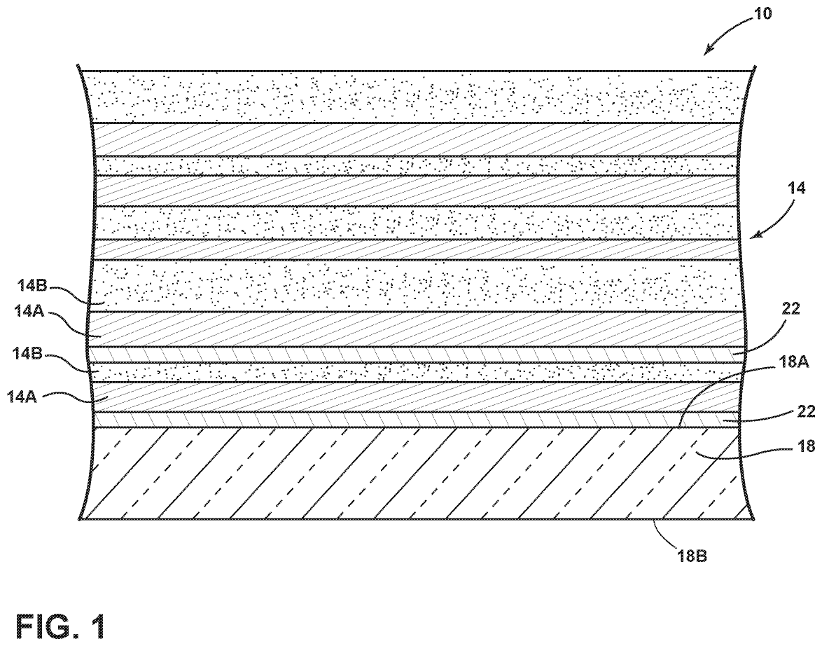

Referring now to FIG. 1, a laminate article 10 includes a film 14 and a substrate 18. As will be explained in detail below, the film 14 may be a multilayered structure which provides a plurality of functional properties including, but not limited to, mechanical properties (e.g., scratch resistance) and optical properties (e.g., anti-reflection and color neutrality).

The substrate 18 may have opposing major surfaces 18A, 18B. The substrate 18 may also define one or more minor surfaces. For purposes of this disclosure, the term “primary surface” may be one or more of the opposing major surfaces 18A, 18B and minor surfaces. According to various examples, the film 14 may be disposed on the primary surface of the substrate 18. The substrate 18 may be a substantially planar sheet, although other examples may utilize a curved or otherwise shaped or sculpted substrate 18. Additionally or alternatively, the thickness of the substrate 18 may vary along one or more of its dimensions for aesthetic and/or functional reasons. For example, the edges of the substrate 18 may be thicker as compared to more central regions of the glass-based substrate 18, or vice-versa. The length, width and thickness dimensions of the substrate 18 may also vary according to the application or use of the laminate article 10.

As explained above, the laminate article 10 includes the substrate 18 on which the film 14 is positioned or disposed. The substrate 18 may include a glass, a glass-ceramic, a ceramic material and/or combinations thereof. Exemplary glass-based examples of the substrate 18 may include soda lime glass, alkali aluminosilicate glass, alkali containing borosilicate glass and/or alkali aluminoborosilicate glass. For purposes of this disclosure, the term “glass-based” may mean a glass, a glass-ceramic and/or a ceramic material. According to various examples, the substrate 18 may be a glass-based substrate. In glass-based examples of the substrate 18, the substrate 18 may be strengthened or strong as explained in greater detail below. The substrate 18 may be substantially clear, transparent and/or free from light scattering. In glass-based examples of the substrate 18, the substrate 18 may have a refractive index in the range from about 1.45 to about 1.55. Further, the substrate 18 of the laminate article 10 may include sapphire and/or polymeric materials. Examples of suitable polymers include, without limitation: thermoplastics including polystyrene (PS) (including styrene copolymers and blends), polycarbonate (PC) (including copolymers and blends), polyesters (including copolymers and blends, including polyethyleneterephthalate and polyethyleneterephthalate copolymers), polyolefins (PO) and cyclicpolyolefins (cyclic-PO), polyvinylchloride (PVC), acrylic polymers including polymethyl methacrylate (PMMA) (including copolymers and blends), thermoplastic urethanes (TPU), polyetherimide (PEI) and blends of these polymers with each other. Other exemplary polymers include epoxy, styrenic, phenolic, melamine, and silicone resins.

According to various examples, the substrate 18 can have a thickness ranging from about 50 μm to about 5 mm. Exemplary thicknesses of the substrate 18 range from 1 μm to 1000 μm, or 100 μm to 500 μm. For example, the substrate 18 may have a thickness of about 100 μm, 200 μm, 300 μm, 400 μm, 500 μm, 600 μm, 700 μm, 800 μm, 900 μm or 1000 μm. According to other examples, the glass-based substrate 18 may have a thickness greater than or equal to about 1 mm, about 2 mm, about 3 mm, about 4 mm, or about 5 mm. In one or more specific examples, the glass-based substrate 18 may have a thickness of 2 mm or less or less than 1 mm. The substrate 18 may be acid polished or otherwise treated to remove or reduce the effect of surface flaws.

The substrate 18 may be relatively pristine and flaw-free (for example, having a low number of surface flaws or an average surface flaw size less than about 1 μm). Where strengthened or strong glass-based substrates 18 are utilized, such substrates 18 may be characterized as having a high average flexural strength (when compared to glass-based substrates 18 that are not strengthened or strong) or high surface strain-to-failure (when compared to glass-based substrates 18 that are not strengthened or strong) on one or more major opposing surfaces of such substrates 18.

Suitable substrates 18 may exhibit an elastic modulus (e.g., Young's modulus) in the range from about 30 GPa to about 120 GPa. In some instances, the elastic modulus of the substrate may be in the range from about 30 GPa to about 110 GPa, from about 30 GPa to about 100 GPa, from about 30 GPa to about 90 GPa, from about 30 GPa to about 80 GPa, from about 30 GPa to about 70 GPa, from about 40 GPa to about 120 GPa, from about 50 GPa to about 120 GPa, from about 60 GPa to about 120 GPa, from about 70 GPa to about 120 GPa, and all ranges and sub-ranges therebetween. The Young's modulus value recited for substrates in this disclosure refers to a value as measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.”

Glass-based examples of the substrate 18 may be provided using a variety of different processes. For instance, forming methods of the glass-based substrate 18 include float glass processes, rolling processes, tube forming processes, and down-draw processes such as fusion draw and slot draw.

Once formed, glass-based examples of the substrate 18 may be strengthened to form strengthened glass-based substrates 18. Strengthened glass-based substrates may have been chemically, thermally, or otherwise, strengthened, for example through ion-exchange of larger ions for smaller ions in the surface of the glass-based substrate 18. However, other strengthening methods known in the art, such as thermal tempering, may be utilized to form strengthened examples of the glass-based substrates 18. As will be described, strengthened glass-based substrates may include a glass-based substrate 18 having a surface compressive stress in its surface (e.g., one or more of the opposing major surfaces 18A, 18B and/or minor surfaces) that aids in the strength preservation of the glass-based substrate 18. “Strong” glass-based substrates 18 are also within the scope of this disclosure. Strong substrates include glass-based substrates 18 that may not have undergone a specific strengthening process, and may not have a surface compressive stress, but are nevertheless strong. For example, the strong glass-based substrates 18 may be formed with and/or may be polished to have a pristine surface which reduces the average flaw size and/or number of flaws. Such strong glass-based substrates 18 may be defined as glass sheet articles or glass-based substrates having an average strain-to-failure greater than about 0.5%, 0.7%, 1%, 1.5%, or even greater than 2%. Such strong glass-based substrates 18 can be made, for example, by protecting the pristine glass surfaces after melting and forming the glass-based substrate 18. An example of such protection occurs in a fusion draw method, where the surfaces of the glass films do not come into contact with any part of the apparatus or other surface after forming. The glass-based substrates 18 formed from a fusion draw method may derive their strength from their pristine surface quality. A pristine surface quality can also be achieved through etching or polishing and subsequent protection of glass-based substrate surfaces, and other methods known in the art. In one or more examples, both strengthened glass-based substrates 18 and the strong glass-based substrates 18 may have an average strain-to-failure greater than about 0.5%, 0.7%, 1%, 1.5%, or even greater than 2%, for example when measured using ring-on-ring testing.

As mentioned above, the glass-based examples of the substrates 18 employed in the laminate articles 10 described herein (see FIG. 1) may be chemically strengthened by an ion-exchange process to provide a strengthened glass-based substrate 18. The glass-based substrate 18 may also be strengthened by other methods known in the art, such as thermal tempering. In the ion-exchange process, typically by immersion of the glass-based substrate 18 into a molten salt bath for a predetermined period of time, ions at or near the surface(s) of the glass-based substrate 18 are exchanged for larger metal ions from the salt bath. According to various examples, the temperature of the molten salt bath is about 350° C. to 450° C. and the predetermined time period is about two to about eight hours. The incorporation of the larger ions into the glass-based substrate 18 strengthens the glass-based substrate 18 by creating a compressive stress in a near surface region or in regions at and adjacent to the surface(s) (e.g., the opposing major surfaces 18A, 18B) of the glass-based substrate 18. A corresponding tensile stress is induced within a central region or regions at a distance from the surface(s) of the glass-based substrate 18 to balance the compressive stress. Glass-based substrates 18 utilizing this strengthening process may be described more specifically as chemically-strengthened glass-based substrates 18 or ion-exchanged glass-based substrates 18. Glass-based substrates 18 that are not strengthened may be referred to herein as non-strengthened glass-based substrates 18.

According to various examples, sodium ions in a strengthened glass-based substrate 18 are replaced by potassium ions from the molten bath, such as a potassium nitrate salt bath, though other alkali metal ions having larger atomic radii, such as rubidium or cesium, can replace smaller alkali metal ions in the glass. In some examples, smaller alkali metal ions in the glass can be replaced by Ag⁺ ions. Similarly, other alkali metal salts such as, but not limited to, sulfates, phosphates, halides, and the like may be used in the ion-exchange process.

The replacement of smaller ions by larger ions at a temperature below that at which the glass network in the glass-based substrate 18 can relax produces a distribution of ions across the surface(s) of the strengthened glass-based substrate 18 that results in a stress profile. The larger volume of the incoming ion produces a compressive stress (CS) on the surface and tension (central tension, or CT) in the center of the strengthened glass-based substrate 18. The depth of the ion-exchange may be described as the depth within the strengthened glass-based substrate 18 (i.e., the distance from a surface of the glass-based substrate to a central region of the glass-based substrate), at which ion exchange facilitated by the ion-exchange process takes place. As such, the substrate 18 may have a compressive stress region.

Strengthened examples of the glass-based substrates 18 can have a surface compressive stress of greater than or equal to about 300 MPa, 400 MPa, 450 MPa, 500 MPa, 550 MPa, 600 MPa, 650 MPa, 700 MPa, 750 MPa or greater than or equal to about 800 MPa. The strengthened glass-based substrate 18 may have a depth-of-compression (DOC) of from about 15 μm to about 100 μm. In yet other examples, the glass-based substrate 18 may have a depth-of-compression in the glass-based substrate 18 of about 5 μm or greater, 10 μm or greater, 15 μm or greater, 20 μm or greater, 25 μm or greater, 30 μm or greater, 35 μm or greater, 40 μm or greater, 45 μm or greater, or 50 μm or greater. According to various examples, the glass-based substrate 18 may have a depth-of-compression in the glass-based substrate 18 of about 15 μm or greater. A central tension may exist within the substrate 18 of about 10 MPa or greater, 20 MPa or greater, 30 MPa or greater, 40 MPa or greater, 42 MPa or greater, 45 MPa or greater, or about 50 MPa or greater. The central tension may be less than or equal to about 100 MPa, 95 MPa, 90 MPa, 85 MPa, 80 MPa, 75 MPa, 70 MPa, 65 MPa, 60 MPa, or less than or equal to about 55 MPa. In one or more specific examples, the strengthened glass-based substrate 18 has one or more of the following: a surface compressive stress greater than 500 MPa, a depth-of-compression greater than 15 μm, and a central tension greater than 18 MPa.

Compressive stress (including surface CS) is measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety. As used herein, DOC means the depth at which the stress in the chemically strengthened glass-based article described herein changes from compressive to tensile. DOC may be measured by FSM or a scattered light polariscope (SCALP) depending on the ion exchange treatment. Where the stress in the glass-based article is generated by exchanging potassium ions into the glass-based article, FSM is used to measure DOC. Where the stress is generated by exchanging sodium ions into the glass-based article, SCALP is used to measure DOC. Where the stress in the glass-based article is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass-based articles is measured by FSM. Maximum CT values are measured using a scattered light polariscope (SCALP) technique known in the art.

Without being bound by theory, it is believed that strengthened glass-based substrates 18 with a surface compressive stress greater than 500 MPa and a depth-of-compression greater than about 15 μm typically have greater strain-to-failure than non-strengthened glass-based substrates 18 (or, in other words, glass-based substrates that have not been ion-exchanged or otherwise strengthened). According to various examples, the benefits of one or more examples described herein may not be as prominent with non-strengthened or weakly strengthened types of glass-based substrates 18 that do not meet these levels of surface compressive stress or depth-of-compression, because of the presence of handling or common glass surface damage events in many typical applications. In other specific applications where the surfaces of the glass-based substrate 18 can be adequately protected from scratches or surface damage (e.g., by a protective coating or other layers), strong glass-based substrates 18 with a relatively high strain-to-failure can also be created through forming and protection of a pristine glass surface quality, using methods such as the fusion forming method. In these alternate applications, the benefits of one or more examples described herein can be similarly realized.

Exemplary ion-exchangeable glasses that may be used in the strengthened glass-based substrate 18 may include alkali aluminosilicate glass compositions or alkali aluminoborosilicate glass compositions, though other glass compositions are contemplated. As used herein, “ion-exchangeable” means that a glass-based substrate 18 is capable of exchanging cations located at or near the surface of the glass-based substrate with cations of the same valence that are either larger or smaller in size. One exemplary glass composition includes SiO₂, B₂O₃ and Na₂O, where (SiO₂+B₂O₃)≥66 mol. %, and Na₂O≥9 mol. %. In another example, the glass-based substrate 18 includes a glass composition with about 6 wt. % or more aluminum oxide. In another example, a glass-based substrate 18 includes a glass composition with one or more alkaline earth oxides, such that a content of alkaline earth oxides is about 5 wt. % or more. Suitable glass compositions, in some examples, further include one or more of K₂O, MgO, and CaO. In a specific example, the glass compositions used in the glass-based substrate 18 can include 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further exemplary glass composition suitable for the glass-based substrate 18, which may optionally be strengthened or strong, includes: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)≤10 mol. %.

A still further exemplary glass composition suitable for the glass-based examples of the substrate 18, which may optionally be strengthened or strong, includes: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %.

In a particular example, an alkali aluminosilicate glass composition suitable for the glass-based substrate 18, which may optionally be strengthened or strong, includes alumina, one or more alkali metal and, in some embodiments, about 50 mol. % or more SiO₂, in other examples about 58 mol. % or more SiO₂, and in still other examples about 60 mol. % or more SiO₂, wherein the ratio

$$\frac{{Al}_{2} {O}_{3} + {B}_{2} {O}_{3}}{\sum modifiers } > 1 ,$$

wherein the ratio of components are expressed in mol. % and the modifiers are alkali metal oxides. This glass composition, in particular examples, includes: 58-72 mol. % SiO₂; 9-17 mol. % Al₂O₃; 2-12 mol. % B₂O₃; 8-16 mol. % Na₂O; and 0-4 mol. % K₂O, wherein the ratio

$$\frac{{Al}_{2} {O}_{3} + {B}_{2} {O}_{3}}{\sum modifiers } > 1.$$

In still another example, the glass-based substrate 18, which may optionally be strengthened or strong, may include an alkali aluminosilicate glass composition comprising: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≤SiO₂+B₂O₃+CaO≤69 mol. %; Na₂O+K₂O+B₂O₃+MgO+CaO+SrO>10 mol. %; 5 mol. %≤MgO+CaO+SrO≤8 mol. %; (Na₂O+B₂O₃)≤Al₂O₃≤2 mol. %; 2 mol. %≤Na₂O≤Al₂O₃≤6 mol. %; and 4 mol. %≤(Na₂O+K₂O)≤Al₂O₃≤10 mol. %.

According to various examples, the glass-based examples of the substrate 18, which may optionally be strengthened or strong, may include an alkali silicate glass composition including: 2 mol % or more of Al₂O₃ and/or ZrO₂, or 4 mol % or more of Al₂O₃ᵥ and/or ZrO₂.

According to various examples, the glass-based examples of the substrate 18 may be batched with 0-2 mol. % of one or more fining agent selected from a group that includes Na₂SO₄, NaCl, NaF, NaBr, K₂SO₄, KCl, KF, KBr, and SnO₂.

Still referring to FIG. 1, the film 14 is depicted as positioned directly on the glass-based substrate 18 of the laminate article 10, but it will be understood that one or more layers or films may be positioned between the film 14 and the substrate 18. For example, a crack mitigation layer (e.g., as outlined later in this disclosure), an adhesion layer, an electrically conductive layer, an electrically insulating layer, an optical layer, an anti-reflection layer, a protective layer, a scratch-resistant layer, a high hardness layer, other types of layers and/or combinations thereof may be positioned between the film 14 and the substrate 18. Further, the film 14 may be positioned on more than one surface of the substrate 18. For example, the film 14 may be positioned on the major opposing surfaces 18A, 18B as well as the minor surfaces of the substrate 18.

The term “film,” as applied to the film 14 and/or other films incorporated into the laminate article 10, includes one or more layers that are formed by any known method in the art, including discrete deposition or continuous deposition processes. Such layers may be in direct contact with one another. The layers may be formed from the same material or more than one different material. In one or more alternative examples, such layers may have intervening layers of different materials disposed therebetween. In one or more examples, the film 14 may include one or more contiguous and uninterrupted layers and/or one or more discontinuous and interrupted layers (i.e., layers having different materials formed adjacent to one another). According to various examples, the film 14 is free of macroscopic scratches or defects that are easily visible to the eye.

As used herein, the term “dispose” includes coating, depositing and/or forming a material onto a surface using any known method in the art. The disposed material may constitute a layer, as defined herein. The phrase “disposed on” includes the instance of forming a material onto a surface such that the material is in direct contact with the surface and also includes the instance where the material is formed on a surface, with one or more intervening material(s) between the disposed material and the surface. The intervening material(s) may constitute a layer, as defined herein.

The optical film 14 may be formed using various deposition methods such as vacuum deposition techniques, for example, chemical vapor deposition (e.g., plasma-enhanced chemical vapor deposition, low-pressure chemical vapor deposition, atmospheric pressure chemical vapor deposition, and plasma-enhanced atmospheric pressure chemical vapor deposition), physical vapor deposition (e.g., reactive or nonreactive sputtering or laser ablation), thermal or e-beam evaporation and/or atomic layer deposition. One or more layers of the optical film 14 may include nano-pores or mixed-materials to provide specific refractive index ranges or values.

The thickness of the film 14 may be in the range from about 0.005 micrometers (microns or μm) to about 0.5 μm, or from about 0.01 μm to about 20 μm. According to other examples, the film 14 may have a thickness in the range from about 0.01 μm to about 10 μm, from about 0.05 μm to about 0.5 μm, from about 0.01 μm to about 0.15 μm or from about 0.015 μm to about 0.2 μm. In yet other examples, the film 14 may have a thickness from about 100 nm to about 200 nm. Thickness of the thin film elements (e.g., crack mitigation layer, scratch-resistant film, crack mitigation stack, etc.) was measured by scanning electron microscope (SEM) of a cross-section, transmission electron microscope (TEM), or by optical ellipsometry (e.g., by an n & k analyzer), or by thin film reflectometry. For multiple layer elements (e.g., crack mitigation stack), thickness measurements by SEM or TEM are preferred.

The laminate article 10 and/or film 14 may have an average and/or local optical, or light, photopic optical transmittance in a visible wavelength band (e.g., about 380 nm to about 720 nm) of greater than or equal to about 60% or greater, about 65% or greater, about 70% or greater, about 75% or greater, about 80% or greater, about 85% or greater, about 90% or greater, about 90.5% or greater, about 91% or greater, about 91.5% or greater, about 92% or greater, about 92.5% or greater, about 93% or greater, about 93.5% or greater, about 94% or greater, about 94.5% or greater, about 95%, about 95.5% or greater, about 96% or greater, about 96.5% or greater, about 97% or greater, about 97.5% or greater, about 98% or greater, about 98.5% or greater, about 99% or greater, or about 99.5% or greater. The term “optical transmittance” refers to the amount of light that is transmitted through a medium. The measure of optical transmittance is the difference between the amount of light that enters the medium and the amount of light that exits the medium. In other words, optical transmittance is the light that has traveled through a medium without being reflected, absorbed, or back-scattered. As used herein, “photopic transmittance” mimics the response of the human eye by weighting the transmittance versus wavelength spectrum according to the human eye's sensitivity as explained in greater detail below.

The laminate article 10 and/or film 14 may have a haze of less than or equal to about 10%, 9%, 8%, 7%, 6%, 5%, 4%, 3%, 2% or less than or equal to about 1%. Similarly to the optical transmittance, the haze of the article 10 and/or film 14 may be measured according to standard D1003 of the American Society for Testing and Materials.

The laminate article 10 and/or film 14 may have a low visible light reflectance. For example, an average single-surface photopic reflectance for the film 14 and/or article laminate 10 across the visible wavelength regime (e.g., about 380 nm to about 720 nm) may be about 5% or less, 4.5% or less, 4% or less, 3.5% or less, 3% or less, 2.5% or less, 2% or less, 1.5% or less, 0.9% or less, 0.5% or less, 4.5% or less, or about 0.3% or less. As used herein, “photopic reflectance” mimics the response of the human eye by weighting the reflectance versus wavelength spectrum according to the human eye's sensitivity. Photopic reflectance is also defined as the luminance, or tristimulus Y value of reflected light, according to known conventions such as CIE color space conventions. The “average photopic reflectance” is defined in Equation (1) as the spectral reflectance, R(λ), multiplied by the illuminant spectrum, (λ), and the CIE's color matching function y̅(λ), related to the eye's spectral response:

[symbol]

Rₚ [symbol] =∫_{380 nm}^{720 nm}R(λ)×I(λ)+y̅(λ)dλ (1)

In some instances, the laminate article 10 including the film 14 may exhibit a color shift of about 5 or less as exhibited by the article when viewed at various incident illumination angles from normal incidence, under an illuminant. In some instances the color shift is about 4 or less, 3 or less, 2 or less, 1.9 or less, 1.8 or less, 1.7 or less, 1.6 or less, 1.5 or less, 1.4 or less, 1.3 or less, 1.2 or less, 1.1 or less, 1 or less, 0.9 or less, 0.8 or less, 0.7 or less, 0.6 or less, 0.5 or less, 0.4 or less, 0.3 or less, 0.2 or less, or 0.1 or less. In some embodiments, the color shift may be about 0. The illuminant can include standard illuminants as determined by the CIE, including A series illuminants (representing tungsten-filament lighting), B series illuminants (representing daylight simulating illuminants), C series illuminants (representing daylight simulating illuminants), D series illuminants (representing natural daylight), and F series illuminants (representing various types of fluorescent lighting). In specific examples, the article 10 exhibits a color shift of about 2 or less when viewed at an incident illumination angle from normal incidence under a CIE F2, F10, F11, F12 or D65 illuminant.

The incident illumination angle may be in the range from about 10 degrees to about 80 degrees, from about 10 degrees to about 75 degrees, from about 10 degrees to about 70 degrees, from about 10 degrees to about 65 degrees, from about 10 degrees to about 60 degrees, from about 10 degrees to about 55 degrees, from about 10 degrees to about 50 degrees, from about 10 degrees to about 45 degrees, from about 10 degrees to about 40 degrees, from about 10 degrees to about 35 degrees, from about 10 degrees to about 30 degrees, from about 10 degrees to about 25 degrees, from about 10 degrees to about 20 degrees, from about 10 degrees to about 15 degrees, from about 20 degrees to about 80 degrees, from about 20 degrees to about 75 degrees, from about 20 degrees to about 70 degrees, from about 20 degrees to about 65 degrees, from about 20 degrees to about 60 degrees, from about 20 degrees to about 55 degrees, from about 20 degrees to about 50 degrees, from about 20 degrees to about 45 degrees, from about 20 degrees to about 40 degrees, from about 20 degrees to about 35 degrees, from about 20 degrees to about 30 degrees, from about 20 degrees to about 25 degrees, and all ranges and sub-ranges therebetween, away from normal incidence.

The laminate article 10 may exhibit the maximum color shifts described herein at and along all the incident illumination angles in the range from about 10 degrees to about 80 degrees away from normal incidence. In one example, the article may exhibit a color shift of 2 or less at any incident illumination angle in the range from about 10 degrees to about 60 degrees, from about 15 degrees to about 60 degrees, or from about 20 degrees to about 60 degrees away from normal incidence. The color shift is given by Equation (2):

√((a*₂−a_{*1})²+(b*₂−b*₁)²) (2)

where a*₁ and b*₁ are color coordinates of the article when viewed at normal incidence and a*₂, and b*₂ are color coordinates of the article 10 viewed at the incident illumination angle. The color coordinates of the article 10, when viewed at normal incidence and at the incident illumination angle, are both in transmittance or reflectance.

According to various examples, the film 14 includes a plurality of first layers 14A and a plurality of second layers 14B. The layers of the first and second plurality of layers 14A, 14B may be arranged in an alternating manner. In other words, the film 14 may be composed of alternating layers of the first and second plurality of layers 14A, 14B. In the depicted example, the film 14 includes ten layers, but it will be understood that the film 14 may include a number of layers. For example, the film 14 may be composed of two, three, four, five, six, seven, eight, nine, eleven, twelve, thirteen, fourteen, or greater than 14 layers. According to other examples, a total number of the layers of the first and second plurality of layers 14A, 14B is about twenty or less.

The first plurality of layers 14A may be composed of diamond, a diamond film, diamond-containing material, diamond-like carbon, amorphous carbon and/or combinations thereof. For example, the first plurality of layers 14A may contain diamond, nanocrystalline diamond, and ultra-nanocrystalline diamond. Nanocrystalline diamond examples of the first plurality of layers 14A may be composed of polycrystalline diamond having an average crystallite size from about 5 nm to about 1 μm. Ultra-nanocrystalline diamond examples of the first plurality of layers 14A may be composed of polycrystalline diamond having an average crystallite size from about 0.1 nm to about 5 nm. Diamond film examples of the first plurality of layers 14A may have an average crystallite, or grain, size of 50 nm or less or about 10 nm or less. In diamond-like carbon and amorphous carbon examples of the first plurality of layers 14A, the carbon may have an sp3/sp2 bond ratio of greater than about 10%, 20%, 30%, 40%, 50%, 60%, 70%, 80%, 90% or greater than about 99%. Diamond films may be grown using microwave plasma chemical vapor deposition (MPCVD) in a reactor using a CH₄/AR plasma gas mixture. Diamond film examples of the first plurality of layers 14A may be deposited on the substrate 18 at a deposition temperature of about 650° C.

Each of the plurality of first layers 14A may have a thickness of about 1 nm or greater, 5 nm or greater, about 10 nm or greater, about 20 nm or greater, about 30 nm or greater, about 40 nm or greater, about 50 nm or greater, about 60 nm or greater, about 70 nm or greater, about 80 nm or greater, about 90 nm or greater, or about 100 nm or greater. For example, one or more layers of the first plurality of layers 14A has a thickness of about 50 nm or greater. A total thickness of the first plurality of layers 14A (e.g., for all layers added together) may be about 5 nm or greater, about 10 nm or greater, about 20 nm or greater, about 30 nm or greater, about 40 nm or greater, about 50 nm or greater, about 60 nm or greater, about 70 nm or greater, about 80 nm or greater, about 90 nm or greater, or about 100 nm or greater. According to various examples, the first plurality of layers 14A has a total thickness within the film 14 of about 5% or greater of total film thickness, for example about 10% or greater, about 20% or greater, about 30% or greater, about 40% or greater, about 50% or greater, about 60% or greater, or about 70% or greater. Such a feature may be advantageous in that by increasing the total amount of diamond or diamond material in the film 14, a hardness of the diamond will be more effective in increasing the hardness of the film 14.

According to various examples, the plurality of first layers 14A may have a high refractive index, relative to the plurality of second layers 14B. The plurality of first layers 14A may have a refractive index of about 1.7 or greater, 1.75 or greater, 1.8 or greater, 1.85 or greater, 1.9 or greater, 1.95 or greater, 2.0 or greater, 2.05 or greater, 2.1 or greater, 2.15 or greater, 2.2 or greater, 2.25 or greater, 2.3 or greater, 2.35 or greater, 2.4 or greater, 2.45 or greater, 2.5 or greater, or 2.6 or greater at a wavelength of 550 nm. In a specific example, the refractive index of one or more of the plurality of first layers 14A may be about 2.33 at 550 nm and an imaginary component of the index (k value, or extinction coefficient) may be about 0.0128 at 550 nm. According to various examples, each layer of the first plurality of layers has a refractive index of about 2.0 or greater at a wavelength of 550 nm. It will be understood that the refractive index of each of the plurality of the first layers 14A may be different than the other layers.

According to various examples, each of the first plurality of layers 14A exhibits a maximum hardness of about 10 GPa or greater, about 20 GPa or greater, about 30 GPa or greater, about 40 GPa or greater, about 50 GPa or greater, about 60 GPa or greater as measured by a Berkovich Indenter Hardness Test when measured as a single layer of ˜50°-2000 nm thickness or more on a glass substrate (e.g., with substrate hardness of about 7 GPa). As used herein, the “maximum hardness value” of the optical film 14 is reported as measured on an air-side surface (e.g., major surface 18A) of the optical film 14 using the Berkovich Indenter Hardness Test, and the “maximum hardness value” of the optical film 14 is reported as measured on the top surface of the optical film 14 (prior to the application of any adhesion coatings and/or easy-to-clean coatings) using the Berkovich Indenter Hardness Test. More particularly, according to the Berkovich Indenter Hardness Test, hardness of thin film coatings as reported herein was determined using widely accepted nanoindentation practices. See: Fischer-Cripps, A. C., Critical Review of Analysis and Interpretation of Nanoindentation Test Data, Surface & Coatings Technology, 200, 4153-4165 (2006) (hereinafter “Fischer-Cripps”); and Hay, J., Agee, P, and Herbert, E., Continuous Stiffness measurement During Instrumented Indentation Testing, Experimental Techniques, 34 (3) 86-94 (2010) (hereinafter “Hay”). For coatings, it is typical to measure hardness and modulus as a function of indentation depth. So long as the coating is of sufficient thickness, it is then possible to isolate the properties of the coating from the resulting response profiles. It should be recognized that if the coatings are too thin (for example, less than ˜500 nm), it may not be possible to completely isolate the coating properties as they can be influenced from the proximity of the substrate which may have different mechanical properties. See Hay. The methods used to report the properties herein are representative of the coatings themselves. The process is to measure hardness and modulus versus indentation depth out to depths approaching 1000 nm. In the case of hard coatings on a softer glass, the response curves will reveal maximum levels of hardness and modulus at relatively small indentation depths (less than or equal to about 200 nm). At deeper indentation depths both hardness and modulus will gradual diminish as the response is influenced by the softer glass substrate. In this case, the coating hardness and modulus are taken to be those associated with the regions exhibiting the maximum hardness and modulus. In the case of soft coatings on a harder glass substrate, the coating properties will be indicated by lowest hardness and modulus levels that occur at relatively small indentation depths. At deeper indentation depths, the hardness and modulus will gradually increase due to the influence of the harder glass. These profiles of hardness and modulus versus depth can be obtained using either the traditional Oliver and Pharr approach (as described in Fischer-Cripps) or by the more efficient continuous stiffness approach (see Hay).

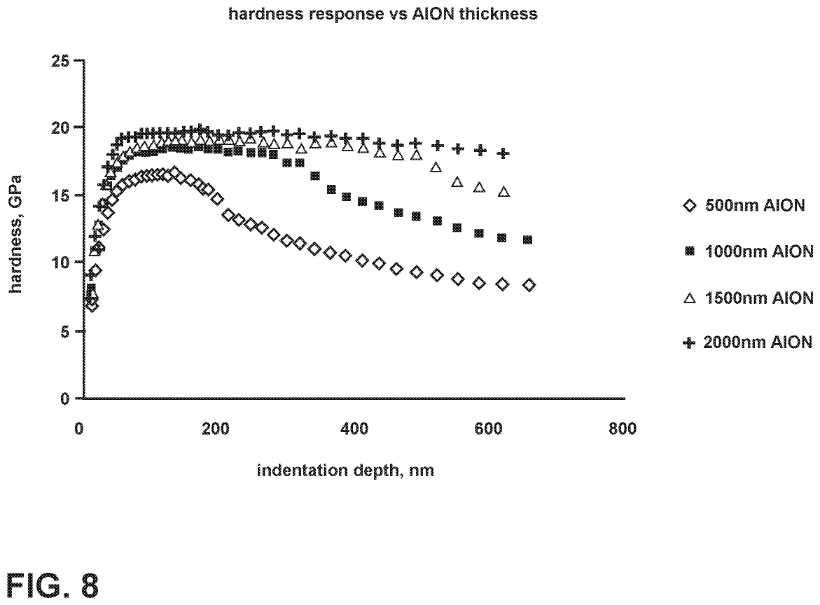

For example, FIG. 8 illustrates the changes in measured hardness value as a function of indentation depth and thickness of a coating. As shown in FIG. 8, the hardness measured at intermediate indentation depths (at which hardness approaches and is maintained at maximum levels) and at deeper indentation depths depends on the thickness of a material or layer. FIG. 8 illustrates the hardness response of four different layers of AlOₓN_{y} having different thicknesses. The hardness of each layer was measured using the Berkovich Indenter Hardness Test. The 500 nm-thick layer exhibited its maximum hardness at indentation depths from about 100 nm to 180 nm, followed by a dramatic decrease in hardness at indentation depths from about 180 nm to about 200 nm, indicating the hardness of the substrate influencing the hardness measurement. The 1000 nm-thick layer exhibited a maximum hardness at indentation depths from about 100 nm to about 300 nm, followed by a dramatic decrease in hardness at indentation depths greater than about 300 nm. The 1500 nm-thick layer exhibited a maximum hardness at indentation depths from about 100 nm to about 550 nm and the 2000-nm thick layer exhibited a maximum hardness at indentation depths from about 100 nm to about 600 nm. Although FIG. 8 illustrates a thick single layer, the same behavior is observed in thinner coatings and those including multiple layers such as the multi-layer optical film 14 of the present disclosure.

The elastic modulus and hardness values reported herein for such thin films were measured using the diamond nanoindentation methods, as described above, with a Berkovich diamond indenter tip.

Typically, in nanoindentation measurement methods (such as by using a Berkovich indenter) of a coating or film that is harder than the underlying substrate, the measured hardness may appear to increase initially due to development of the plastic zone at shallow indentation depths and then increases and reaches a maximum value or plateau at deeper indentation depths. Thereafter, hardness begins to decrease at even deeper indentation depths due to the effect of the underlying substrate. Where a substrate having an increased hardness compared to the coating is utilized, the same effect can be seen; however, the hardness increases at deeper indentation depths due to the effect of the underlying substrate.

The indentation depth range and the hardness values at certain indentation depth range(s) can be selected to identify a particular hardness response of the optical film 14 and layers thereof, described herein, without the effect of the underlying substrate 18. When measuring hardness of the optical film 14 or layers thereof (when disposed on a substrate) with a Berkovich indenter, the region of permanent deformation (plastic zone) of a material is associated with the hardness of the material. During indentation, an elastic stress field extends well beyond this region of permanent deformation. As indentation depth increases, the apparent hardness and modulus are influenced by stress field interactions with the underlying substrate 18. The substrate 18 influence on hardness occurs at deeper indentation depths (i.e., typically at depths greater than about 10% of the optical film structure or layer thickness). Moreover, a further complication is that the hardness response may need a certain minimum load to develop full plasticity during the indentation process. Prior to that certain minimum load, the hardness shows a generally increasing trend.

At small indentation depths (which also may be characterized as small loads) (e.g., up to about 100 nm, or less than about 70 nm), the apparent hardness of a material appears to increase dramatically versus indentation depth. This small indentation depth regime does not represent a true metric of hardness, but instead reflects the development of the aforementioned plastic zone, which is related to the finite radius of curvature of the indenter. At intermediate indentation depths, the apparent hardness approaches maximum levels. At deeper indentation depths, the influence of the substrate becomes more pronounced as the indentation depths increase. Hardness may begin to drop dramatically once the indentation depth exceeds about 30% of the optical film structure thickness or the layer thickness.

It has been observed that the hardness measured at intermediate indentation depths (at which hardness approaches and is maintained at maximum levels) and at deeper indentation depths depends on the thickness of a material or layer.

The plurality of second layers 14B may be composed of one or more of SiO₂, Al₂O₃, GeO₂, SiO, AlOxNy, AlN, SiNₓ, Si3N4, SiOₓN_{y}, SiₙAlₓOₓN_{y}, Ta₂O₅, Nb₂O₅, TiO₂, ZrO₂, TiN, MgO, MgF₂, BaF₂, CaF₂, SnO₂, HfO₂, Y₂O₃, MoO₃, DyF₃, YbF₃, YF₃, CeF₃, polymers, fluoropolymers, plasma-polymerized polymers, siloxane polymers, silsesquioxanes, polyimides, fluorinated polyimides, polyetherimide, polyethersulfone, polyphenylsulfone, polycarbonate, polyethylene terephthalate, polyethylene naphthalate, acrylic polymers, urethane polymers, polymethylmethacrylate, and/or combinations thereof. According to various examples, the second plurality of layers 14B may include one or both of SiO₂ and Al₂O₃. Additional examples of materials that can be utilized in the second plurality of layers 14B include Al-doped SiO₂, SiOₓN_{y}, SiₙAlₓOₓN_{y}, AlOₓN_{y}, and Al₂O₃. Pure SiO₂ may be utilized in the second plurality of layers 14B in some examples where low reflectance of the film 14 is prioritized over maximizing hardness of the overall film structure. Materials such as Al₂O₃ can be crystalline or amorphous depending on film deposition process and temperature. Al₂O₃ films may be preferred for use in layers 14B to increase the hardness of the overall film structure, while typically adding a slight increase in reflectance. Crystalline examples may be advantageous in increasing the hardness of the film 14. Amorphous Al₂O₃ and SiO₂ film examples of the second plurality of layers 14B may be formed via a reactive sputtering process.

As used herein, the “AlOₓN_{y},” “SiOₓN_{y},” and “SiₙAlₓOₓN_{z}” materials in the disclosure include various aluminum oxynitride, silicon oxynitride and silicon aluminum oxynitride materials, as understood by those with ordinary skill in the field of the disclosure, described according to certain numerical values and ranges for the subscripts, “u,” “x,” “y,” and “z”. That is, it is common to describe solids with “whole number formula” descriptions, such as Al₂O₃. It is also common to describe solids using an equivalent “atomic fraction formula” description such as Al_{0.4}O_{0.6}, which is equivalent to Al₂O₃. In the atomic fraction formula, the sum of all atoms in the formula is 0.4+0.6=1, and the atomic fractions of Al and O in the formula are 0.4 and 0.6 respectively. Atomic fraction descriptions are described in many general textbooks and atomic fraction descriptions are often used to describe alloys. See, for example: (i) Charles Kittel, Introduction to Solid State Physics, seventh edition, John Wiley & Sons, Inc., NY, 1996, pp. 611-627; (ii) Smart and Moore, Solid State Chemistry, An introduction, Chapman & Hall University and Professional Division, London, 1992, pp. 136-151; and (iii) James F. Shackelford, Introduction to Materials Science for Engineers, Sixth Edition, Pearson Prentice Hall, New Jersey, 2005, pp. 404-418.

Again referring to the “AlOₓN_{y},” “SiO)ₓN_{y},” and “SiₙAlₓOₓN_{z}” materials in the disclosure, the subscripts allow those with ordinary skill in the art to reference these materials as a class of materials without specifying particular subscript values. To speak generally about an alloy, such as aluminum oxide, without specifying the particular subscript values, we can speak of AlₓOₓ. The description AlₓOₓ can represent either Al₂O₃ or Al_{0.4}O_{0.6}. If v+x were chosen to sum to 1 (i.e., v+x=1), then the formula would be an atomic fraction description. Similarly, more complicated mixtures can be described, such as SiₙAlₓOₓN_{y}, where again, if the sum u+v+x+y were equal to 1, we would have the atomic fractions description case.

Once again referring to the “AlOₓN_{y},” “SiOₓN_{y},” and “SiₙAlₓOₓN_{z}” materials in the disclosure, these notations allow those with ordinary skill in the art to readily make comparisons to these materials and others. That is, atomic fraction formulas are sometimes easier to use in comparisons. For instance; an example alloy consisting of (Al₂O₃)_{0.3}(AlN)_{0.7} is closely equivalent to the formula descriptions AlO_{0.448}O_{0.31}N_{0.241} and also Al₃₆₇O₂₅₄N₁₉₈. Another example alloy consisting of (Al₂O₃)_{0.4}(AlN)_{0.6} is closely equivalent to the formula descriptions Al_{0.438}O_{0.375}N_{0.188} and Al₃₇O₃₂N₁₆. The atomic fraction formulas Al_{0.448}O_{0.31}N_{0.241} and Al_{0.438}O_{0.375}N_{0.188} are relatively easy to compare to one another. For instance, Al decreased in atomic fraction by 0.01, O increased in atomic fraction by 0.065 and N decreased in atomic fraction by 0.053. It takes more detailed calculation and consideration to compare the whole number formula descriptions Al₃₆₇O₂₅₄N₁₉₈ and Al₃₇O₃₂N₁₆. Therefore, it is sometimes preferable to use atomic fraction formula descriptions of solids. Nonetheless, the use of AlᵥOₓN_{y} is general since it captures any alloy containing Al, O and N atoms.

As understood by those with ordinary skill in the field of the disclosure with regard to any of the foregoing materials (e.g., AlN) for the optical film 80, each of the subscripts, “u,” “x,” “y,” and “z,” can vary from 0 to 1, the sum of the subscripts will be less than or equal to one, and the balance of the composition is the first element in the material (e.g., Si or Al). In addition, those with ordinary skill in the field can recognize that “SiᵤAlₓO_{y}N_{z}” can be configured such that “u” equals zero and the material can be described as “AlOₓN_{y}”. Still further, the foregoing compositions for the optical film 80 exclude a combination of subscripts that would result in a pure elemental form (e.g., pure silicon, pure aluminum metal, oxygen gas, etc.). Finally, those with ordinary skill in the art will also recognize that the foregoing compositions may include other elements not expressly denoted (e.g., hydrogen), which can result in non-stoichiometric compositions (e.g., SiNₓ vs. Si₃N₄). Accordingly, the foregoing materials for the optical film can be indicative of the available space within a SiO₂—Al₂O₃—SiNₓ—AlN or a SiO₂—Al₂O₃—Si₃N₄—AlN phase diagram, depending on the values of the subscripts in the foregoing composition representations.

Each of the plurality of second layers 14B may have a thickness of about 1 nm or greater, 5 nm or greater, about 10 nm or greater, about 20 nm or greater, about 30 nm or greater, about 40 nm or greater, about 50 nm or greater, about 60 nm or greater, about 70 nm or greater, about 80 nm or greater, about 90 nm or greater, or about 100 nm or greater. For example, one or more layers of the second plurality of layers 14B has a thickness of about 50 nm or greater. A total thickness of the second plurality of layers 14B (e.g., for all layers added together) may be about 5 nm or greater of the total film thickness, for example about 10 nm or greater, about 20 nm or greater, about 30 nm or greater, about 40 nm or greater, about 50 nm or greater, about 60 nm or greater, about 70 nm or greater, about 80 nm or greater, about 90 nm or greater, or about 100 nm or greater. According to various examples, each layer of the second plurality of layers 14B has a thickness of about 10 nm or greater. According to various examples, the second plurality of layers 14B has a total thickness within the film 14 of about 5% or greater, about 10% or greater, about 20% or greater, about 30% or greater, about 40% or greater, about 50% or greater, about 60% or greater, or about 70% or greater. According to various examples, one of the second plurality of layers 14B may be substantially thicker than the rest of the second layers 14B of the optical film 14.

According to various examples, the second plurality of layers 14B may have a refractive index lower than the first plurality of layers 14A. For example, one or more of the 1.25 or greater, 1.3 or greater, 1.35 or greater, 1.4 or greater, 1.45 or greater, 1.5 or greater, 1.55 or greater, 1.6 or greater, 1.65 or greater, 1.7 or greater, 1.75 or greater, 1.8 or greater, 1.85 or greater, 1.9 or greater, 1.95 or greater, or 2.0 or greater at a wavelength of 550 nm. According to various examples, each layer of the second plurality of layers 14B has a refractive index of about 1.5 or greater or even 1.6 or greater at a wavelength of 550 nm. According to various examples, the refractive indexes of the first and second plurality of layers 14A, 14B may be different than one another such that the film 14 may function as an anti-reflective film. The difference in the refractive index of the first and second plurality of layers 14A, 14B may be about 0.01 or greater, about 0.05 or greater, about 0.1 or greater, about 0.2 or greater, about 0.3 or greater, about 0.4 or greater, 0.5 or greater, 0.6 or greater, 0.7 or greater, 0.8 or greater, 0.9 or greater, or 1.0 or greater.

According to various examples, each of the second plurality of layers 14B exhibits a maximum hardness of about 1 GPa or greater, about 2 GPa or greater, about 3 GPa or greater, about 4 GPa or greater, about 5 GPa or greater, about 6 GPa or greater, about 7 GPa or greater, about 8 GPa or greater, about 9 GPa or greater, about 10 GPa or greater, about 11 GPa or greater, about 12 GPa or greater, about 13 GPa or greater, about 14 GPa or greater, or about 15 GPa or greater as measured by a Berkovich Indenter Hardness Test when measured as a single layer of ˜500 nm thickness on a glass substrate (with substrate hardness of about 7 GPa). It will be understood that even amorphous Al₂O₃ film examples of the second plurality of layers 14B may have nanoindentation hardness values greater than 10 GPa. As both the first and second plurality of layers 14A, 14B may have a maximum hardness of about 10 GPa or greater as measured by Berkovich Indentation Hardness Testing, a high proportion of the layers of the film 14 may have a maximum hardness of about 10 GPa or greater. For example, about 10% or greater, 20% or greater, 30% or greater, about 40% or greater, 50% or greater, 60% or greater, about 70% or greater, 80% or greater, 90% or greater, or 99% or greater of the layers (calculated as a percentage of total thickness) of the first and second plurality of layers 14A, 14B each may be composed of a material having a maximum hardness of about 10 GPa or greater as measured by Berkovich Indentation Hardness Testing.

Still referring to FIG. 1, the laminate article 10 may include one or more seed layers 22. In the depicted example, the seed layer 22 is positioned between the substrate 18 and the film 14, but it will be understood that the seed layer 22 may be positioned within the film 14. For example the seed layer 22 may be positioned between one or more of the first and second plurality of layers 14A, 14B. Although depicted with two seed layers 22, it will be understood that the article 10 may include a plurality of seed layers 22, or a single seed layer 22. The seed layer 22 may have a thickness of from about 1 nm to about 10 nm. The seed layer 22 may have an optical transmittance of about 5% or greater, 10% or greater, 20% or greater, 30% or greater, 40% or greater, 50% or greater, 60% or greater, 70% or greater, 80% or greater, 90% or greater, or 95% or greater. The optical transmittance of the seed layer 22 may be measured in a substantially similar manner to that described in connection with the film 14. Lower optical transmittance values of the seed layer 22 may be advantageous for applications such as sunglasses, automotive windows and/or dashboards while higher optical transmittance values may be advantageous for use of the article 10 in consumer electronics and display applications. It should also be noted that the small amount of blue absorption imparted by the diamond-like layers (resulting in a yellow-shifted transmitted color) may be desirable for certain applications such as sunglasses or eyeglasses, where blue and UV light absorption provides benefits such as reduced eye strain and reduced eye damage/aging.

The seed layer 22 may include metals, insulators and/or carbonaceous materials (e.g., amorphous carbon, DLC, C-70, and/or graphitic material) as well as carbide films such as tungsten carbide or SiC may also be utilized. According to some examples, the seed layer 22 may be composed of thin metal films such as W and/or Mo. According to yet other examples, non-metallic materials may be used for the seed layer 22 such as TiO₂, Nb₂O₅, SiOC, SiNₓ, AlNₓ, and Y₂O₃—ZrO₂. Other oxides, nitrides, or oxycarbides may also be utilized in the seed layer 22. The seed layer 22 may be applied to the film 14 and/or substrate via electrostatic deposition and/or any of the method described above in connection with the film 14.

According to various examples, the seed layer 22 may be configured to nucleate diamond. Such a feature may be advantageous in forming a continuous diamond layer (e.g., the plurality of second layers 14B) at the nano scale thicknesses for some anti-reflective coating designs of the film 14. Conventional methods of nucleating diamond have been accomplished by using surface roughening, coating, abrasion, or ultrasonication with dispersed diamond nanocrystals. As use of the seed layer 22 may nucleate diamond, diamond particulate processing may not be required which may be advantageous. It will be understood that use of the seed layer 22 may be combined with diamond abrasion or ultrasonication steps to aid the nucleation of nanocrystalline diamond and/or ultra-nanocrystalline diamond.

According to various examples of the laminate article 10, the optical film 14 may also be disposed over a crack mitigating layer (not shown). This crack mitigating layer may suppress or prevent crack bridging between the film 14 and the substrate 18, thus modifying or improving the mechanical properties or strength of the article 10. Embodiments of crack mitigating layers are further described in U.S. patent application Ser. Nos. 14/052,055, 14/053,093 and 14/053,139, the salient portions of which that relate to crack mitigating layers are incorporated herein by reference. The crack mitigating layer may include crack blunting materials, crack deflecting materials, crack arresting materials, tough materials, or controlled-adhesion interfaces. The crack mitigating layer may comprise polymeric materials, nanoporous materials, metal oxides, metal fluorides, metallic materials, or other materials mentioned herein for use in the film 14. The structure of the crack mitigating layer may be a multilayer structure, wherein the multilayer structure is designed to deflect, suppress, or prevent crack propagation. The crack mitigating layer may include nanocrystallites, nanocomposite materials, transformation toughened materials, multiple layers of organic material, multiple layers of inorganic material, multiple layers of interdigitating organic and inorganic materials, or hybrid organic-inorganic materials. The crack mitigating layer may have a strain-to-failure that is greater than about 2%, or greater than about 10%. These crack mitigating layers can also be combined separately with the substrate 18 or the film 14.

The crack mitigating layer may include tough or nanostructured inorganics, for example, zinc oxide, certain Al alloys, Cu alloys, steels, or stabilized tetragonal zirconia (including transformation toughened, partially stabilized, yttria stabilized, ceria stabilized, calcia stabilized, and magnesia stabilized zirconia); zirconia-toughened ceramics (including zirconia-toughened alumina); ceramic-ceramic composites; carbon-ceramic composites; fiber- or whisker-reinforced ceramics or glass-ceramics (for example, SiC or Si₃N₄ fiber- or whisker-reinforced ceramics); metal-ceramic composites; porous or non-porous hybrid organic-inorganic materials, for example, nanocomposites, polymer-ceramic composites, polymer-glass composites, fiber-reinforced polymers, carbon-nanotube- or graphene-ceramic composites, silsesquioxanes, polysilsesquioxanes, or “ORMOSILs” (organically modified silica or silicate), and/or a variety of porous or non-porous polymeric materials, for example siloxanes, polysiloxanes, polyacrylates, polyacrylics, PI (polyimides), fluorinated polyimide, polyamides, PAI (polyamideimides), polycarbonates, polysulfones, PSU or PPSU (polyarylsulfones), fluoropolymers, fluoroelastomers, lactams, polycylic olefins, and similar materials, including, but not limited to PDMS (polydimethylsiloxane), PMMA (poly(methyl methacrylate)), BCB (b enzocyclobutene), PEI (polyethyletherimide), poly(arylene ethers) such as PEEK (poly-ether-ether-ketone), PES (polyethersulfone) and PAR (polyarylate), PET (polyethylene terephthalate), PEN (polyethylene napthalate-poly(ethylene-2,6-napthalene dicarboxylate), FEP (fluorinated ethylene propylene), PTFE (polytetrafluoroethylene), PFA (perfluoroalkoxy polymer, e.g., trade names Teflon®, Neoflon®) and similar materials. Other suitable materials include modified polycarbonates, some versions of epoxies, cyanate esters, PPS (polyphenylsulfides), polyphenylenes, polypyrrolones, polyquinoxalines, and bismaleimides.

An exemplary method of forming the optical film 14 may include a variety of steps.

The method may begin by depositing a plurality of first layer layers 14A including diamond or diamond-like carbon on the primary surface (e.g., one or more of the major opposing surfaces 18A, 18B) of glass-based examples of the substrate 18. The step of depositing the first layers 14A may be performed such that about 40% or greater of a total thickness of the optical film 14 includes the plurality of first of layers 14A. Further, the plurality of first layers may be deposited such that an sp3/sp2 bond ratio of each layer of the first plurality of layers 14A is about 50% or greater. Next, a step of depositing the second plurality of layers 14B arranged in an alternating manner with each layer of the first plurality of layers 14A such that the optical film 14 includes an average photopic light reflection of about 2.0% or less and a transmittance of about 85% or greater over the wavelength range of from about 500 nm to about 800 nm. The deposition of the plurality of second players 14B may be performed such that one or more of the plurality of second layers 14B has a thickness of about 10 nm or greater. The method may further include a step of depositing the seed layer 22, which includes a diamond nucleating material, between one or more of the first and second layers 14A, 14B.

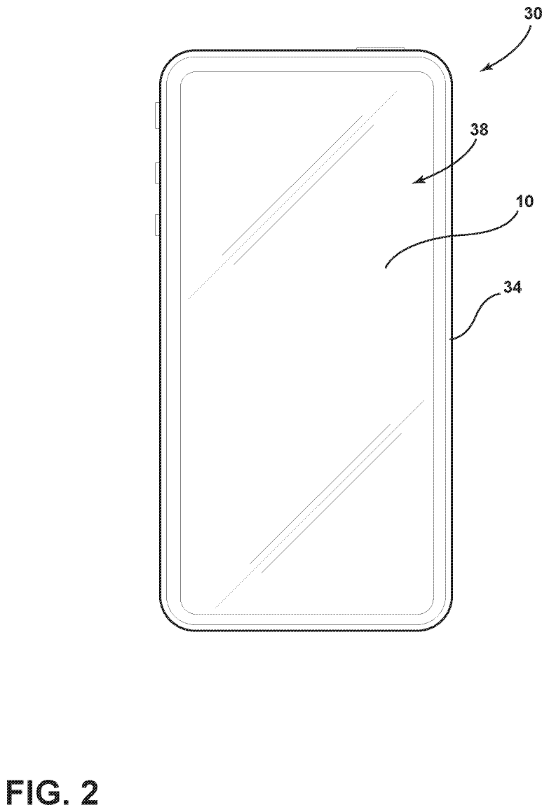

Referring now to FIG. 2, the laminate article 10 may be incorporated into an electronic device 30. Although depicted as a mobile telephone, the electronic device 30 may be a tablet, portable music device, television, computer monitor, or any kind of electronic device 30 which may graphically display information (e.g., video, pictures, etc.). The electronic product 30 includes a housing 34 having a front surface, a back surface and side surfaces. Electrical components may be provided partially or fully within the housing 34. The electrical components may include one or more of a controller, a memory, and a display. The display may be provided at or adjacent the front surface of the housing 34. A cover glass 38 is disposed over the display. According to various examples, a portion of the housing 34 and/or the cover glass 38 includes the article 10 as described herein.

Use of the concepts described in the present disclosure may offer a variety of advantages. First, the incorporation of diamond at high percentages (e.g., about 10% or greater) within the film 14 enables higher film durability and scratch resistance than typical film materials. Second, due to the relatively high refractive index of diamond and diamond-like materials, “low” refractive index layers within anti-reflective examples of the film 14 may have a higher, and harder, material than traditional anti-reflective films. Diamond containing materials alone may not be able to provide an anti-reflective function due to its high refractive index, but the high index of diamond provides design flexibility when pairing diamond with a lower-refractive-index material (which is necessary to achieve reflection-reducing interference effects). For example, use of diamond or diamond like materials having a high refractive index in the first plurality of layers 14A allows the second plurality of layers 14B to utilize a higher refractive index material, relative to conventional designs, such as Al₂O₃. Medium-to-high refractive index materials such as Al₂O₃ typically have a higher hardness than lower-index materials such as SiO₂ and MgF₂. Thus, an anti-reflective film stack that is predominantly made with diamond-like material and Al₂O₃, or a film stack whose lowest-index or lowest-hardness component is similar to Al₂O₃, will have a high total hardness and scratch resistance as compared to film stacks that have significant amounts of low-index, low-hardness materials such as SiO₂ or MgF₂. The ability to use higher refractive index materials increases the breadth of materials that may be utilized in the second plurality of layers 14B. Third, as the use of diamond in the first plurality of layers 14A allows for the increased refractive index of the second plurality of layers 14B, harder materials may be utilized for the second plurality of layers 14B. As explained above, use of the present disclosure allows for about 10% or greater, 50% or greater, 80% or greater, 90% or greater, or 99% or greater of the layers of the first and second plurality of layers 14A, 14B, each may be composed of a material having a maximum hardness of about 10 GPa or greater as measured by Berkovich Indentation Hardness Testing.

The following examples represent certain non-limiting examples of the disclosure.

### Examples

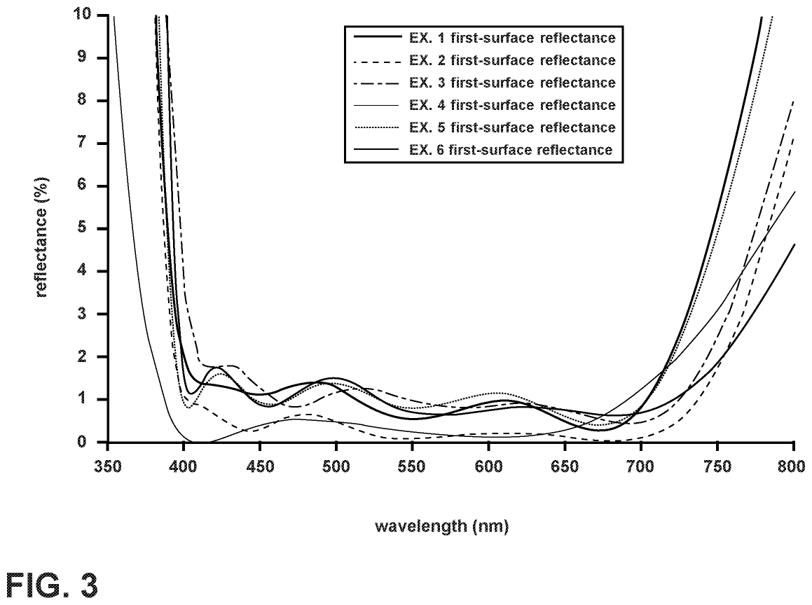

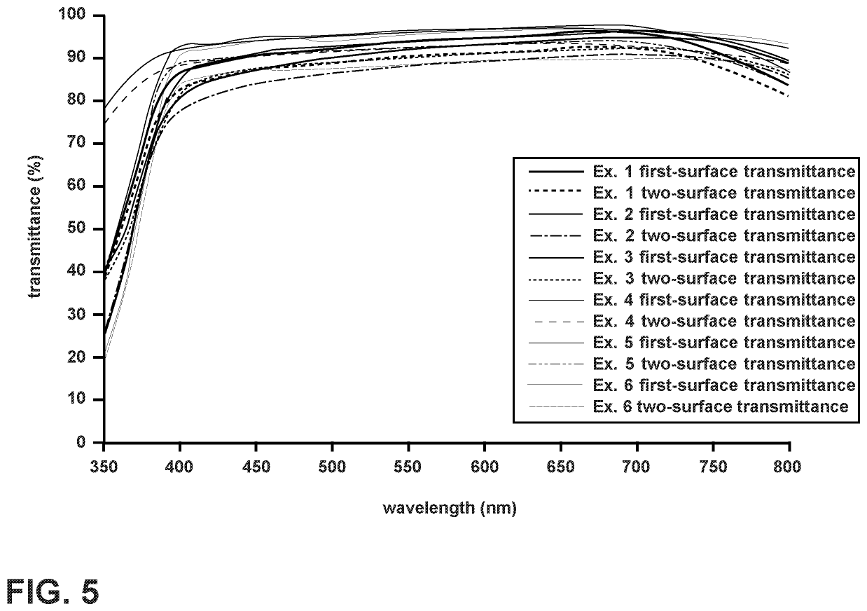

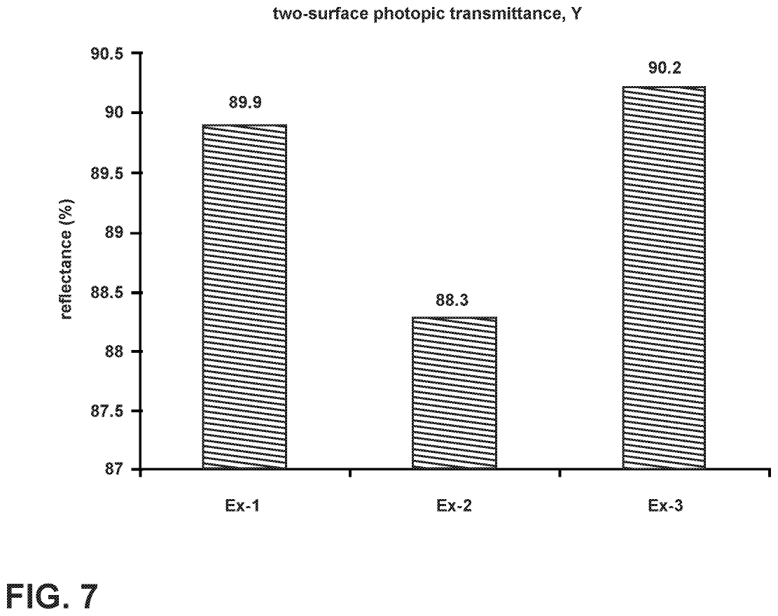

Referring now to FIGS. 3-7, depicted are plots of simulated optical data for six different examples consistent with the laminate articles 10 of the disclosure.

Example 1 is a coated article (e.g., the laminate article 10) having an anti-reflective coating (e.g., the film 14) on a surface (e.g., the primary surface of the substrate 18). The coating of Example 1 has a layered structure given by Table 1.

TABLE 1

| Material | Thickness (nm) | Element |
|---|---|---|
| Air | | |
| Al₂O₃ | 80.10 | AR Coating |
| Diamond film | 57.26 | AR Coating |
| Al₂O₃ | 29.17 | AR Coating |
| Diamond film | 16.85 | AR Coating |
| Al₂O₃ | 94.47 | AR Coating |
| Diamond film | 27.68 | AR Coating |
| Al₂O₃ | 19.38 | AR Coating |
| Diamond film | 56.24 | AR Coating |
| Al₂O₃ | 40.22 | AR Coating |
| Diamond film | 11.22 | AR Coating |
| Glass | | Substrate |

Example 1 has an average photopic reflectance at normal incidence of less than about 1.0 or less than about 0.9%. A single-surface reflected b* value may be about 0 at near normal incidence (e.g., 0°). The single-surface reflected b* value may be less than about 0 for all angles of incidence between about 0° and about 60°. The single-surface reflected b* value may be less than about 2 for all angles of incidence between about 0° and about 90°. The single-surface reflected b* value may be from about −7 to about 2 for all angles of incidence between about 0° and about 90° degrees. The coating may also have an a* value less than 5 for all angles of incidence between about 0° and about 60°, or about 0° and about 90°. The coating may also have an a* value from about −5 to about 5 for all angles of incidence from about 0° to about 60°, or about 0° to about 90°. The coating may have a maximum first-surface reflected color shift for any and all viewing angle pairs from about 0° to about 60°, or about 0° to about 90° of less than about 7, when calculated using Equation (1) provided above. The coating and/or coated article may have a single-surface or two-surface average photopic transmittance of about 80% or greater, or about 90% or greater, or about 93% or greater where the second surface in transmission is a glass surface which reduces transmittance by about 4%. A single-surface or two-surface transmitted color of the coating and/or coated article may be from about 3 to about −3 in b* and from about 2 to about −2 in a* for all viewing angles between 0° and 60° or from 0° to 90°. The coating may have a maximum two-surface transmitted color shift for any and all viewing angle pairs between 0° and 60° or 0° and 84° of about 2 or less, or about 1.5 or less, when calculated using Equation (1).

The coating or coated article can have an indentation hardness of about 8 GPa or greater or about 10 GPa or greater. The coating or coated article may include a multilayer stack (e.g., the film 14 having the plurality of first and second layers 14A, 14B) where each layer of material has a hardness of about 8 GPa or greater, or about 10 GPa or greater when measured as a single layer of −500 nm thickness on a glass substrate (with substrate hardness of about 7 GPa) to evaluate the individual coating material hardness. The anti-reflective coating includes a multilayer stack of diamond or diamond material as the high index component (e.g., the first plurality of layers 14A) of the anti-reflective coating. A total thickness of all diamond layers added together is about 169 nm with diamond film amounting to 39% of the thickness of the full anti-reflective coating stack. Al₂O₃ or a similar material having a hardness of about 8 GPa or greater and/or a refractive index of about 1.5 or greater, about 1.55 or greater, or about 1.6 or greater is the lower index component (e.g., of the second plurality of layers 14B) of the multilayer anti-reflective stack.

The relatively low value of k (compared to other diamond film materials) enables the incorporation of more diamond-containing film material in an anti-reflection multilayer film stack (e.g., the film 14) without creating too much optical absorption or color. In addition, the high n value of 2.33 for the higher-index component of an anti-reflection multilayer stack (e.g., first plurality of layers 14A) enables the use of relatively higher-index “secondary” materials (e.g., the second plurality of layers 14B) in the anti-reflection coating stack. While a typical secondary material (lower-index material) in an anti-reflection stack such as SiO₂ has a refractive index around 1.46, the higher-index of diamond-containing films enables efficient anti-reflection coating designs where even the secondary (lower-index material) can have an index higher than 1.5, 1.55, 1.6, or even higher than 1.65 at 550 nm. These anti-reflection coating stacks may in some cases exclude any materials in the stack with indices below these thresholds. This is desirable because a higher refractive index is often correlated to higher material hardness, through the mechanism of higher bond density and higher electron density which influences both hardness and refractive index. Thus, a harder anti-reflection coating can be designed if all of the materials in the multilayer stack can have relatively high refractive indices.

The optical properties described above can also be achieved using a multi-layer film including diamond or diamond material as the high index component of the anti-reflective stack and SiO₂ as the low-index component of the anti-reflective stack. The use of SiO₂ will lower the hardness of the anti-reflective stack, but still may be desirable for some applications, for example where very low reflectance is desired. These diamond-SiO₂ anti-reflective stacks may be desirable in that they incorporate a high thickness or high fraction of diamond or diamond material, but can achieve the reflectance, transmittance, and color targets described above. Refractive index values of the materials of Example 1 are provided in Tables 2-4

TABLE 2
Diamond film refractive index.
Diamond film

| Wavelength (nm) | n | k |
|---|---|---|
| 401.1 | 2.3849 | 0.01872 |
| 450.2 | 2.3640 | 0.01590 |
| 500.9 | 2.3490 | 0.01404 |
| 549.9 | 2.3385 | 0.01282 |
| 600.5 | 2.3305 | 0.01195 |
| 651 | 2.3243 | 0.01133 |
| 699.8 | 2.3197 | 0.01090 |
| 750.1 | 2.3159 | 0.01057 |
| 800.2 | 2.3128 | 0.01034 |

TABLE 3
Al₂O₃ film refractive index.
Al₂O₃ film

| Wavelength (nm) | n | k |
|---|---|---|
| 401.3 | 1.6868 | 0 |
| 450.7 | 1.6775 | 0 |
| 500.2 | 1.6709 | 0 |
| 549.5 | 1.6661 | 0 |
| 600.5 | 1.6623 | 0 |
| 649.7 | 1.6596 | 0 |
| 700.5 | 1.6573 | 0 |
| 749.7 | 1.6555 | 0 |
| 800.4 | 1.6540 | 0 |

TABLE 4
Glass substrate refractive index.
Glass Substrate

| Wavelength (nm) | n | k |
|---|---|---|
| 400.9 | 1.5214 | 0 |
| 451.2 | 1.5160 | 0 |
| 501.3 | 1.5126 | 0 |
| 551.5 | 1.5100 | 0 |
| 601.6 | 1.5083 | 0 |
| 651.7 | 1.5063 | 0 |
| 701.8 | 1.5045 | 0 |
| 749.9 | 1.5049 | 0 |

Example 2 is a coated article having a diamond-SiO₂ anti-reflective coating (e.g., diamond as the first plurality of layers 14A and SiO₂ as the second plurality of layers 14B). The coating of Example 2 has a layered structure given by Table 5.

TABLE 5

| Material | Thickness (nm) | Element |
|---|---|---|
| Air | | |
| SiO₂ | 86.37 | AR Coating |
| Diamond film | 54.65 | AR Coating |
| SiO₂ | 10.10 | AR Coating |
| Diamond film | 40.58 | AR Coating |
| SiO₂ | 79.65 | AR Coating |
| Diamond film | 11.37 | AR Coating |
| SiO₂ | 58.57 | AR Coating |
| Diamond film | 124.13 | AR Coating |
| SiO₂ | 40.01 | AR Coating |
| Diamond film | 12.67 | AR Coating |
| Glass | | Substrate |

Example 2 has a total thickness of diamond material for all layers added together of about 243 nm. The diamond material constitutes about 47% of the thickness of the full coating stack. The thickest diamond layer has a thickness of about 124 nm. Example 2 has a coated-surface photopic average reflectance at normal incidence less than 0.5% or even less than 0.25% and a single-surface reflected b* value less than 0 near normal incidence (0 degrees), less than or equal to 0 for all angles of incidence between about 0° and about 60° and between about 0° and about 90°, or between −5 and 0.5 for all angles of incidence between about 0° and about 90°. This same coating also has an a* value or about 2 or less for all angles of incidence between about 0° and about 60° or about 0° and about 90°, or an a* value of between about −6 and 1 for all angles of incidence between about 0° and about 60° or about 0° and about 90°. The coating of Example 2 may have a maximum first-surface reflected color shift for any and all viewing angle pairs between about 0° and about 60° or about 0° and about 90° of less than about 7, when calculated using equation 1 above. This coating/coated article of Example 2 also has a single-surface or two-surface average photopic transmittance at normal incidence greater than 80% or greater than 90% or greater than 92%, where the second surface in transmission is a glass surface which reduces transmittance by about 4%, with a single-surface or two-surface transmitted color between 5 and −5 in b* and 1 and −1 in a* for all viewing angles between about 0° and about 60° or about 0° and about 90°. The coating of Example 2 may have a maximum two-surface transmitted color shift for any and all viewing angle pairs between about 0° and about 60° or about 0° and about 84° less than about 2 or less than about 1 or even less than about 0.9, when calculated using Equation (1). Refractive index values of the materials of Example 2 are provided in Tables 2, 4 and 6.

TABLE 6
SiO₂ film refractive index.
SiO₂ film

| Wavelength (nm) | n | k |
|---|---|---|
| 400 | 1.4949 | 1.00E−05 |
| 450 | 1.4890 | 0 |
| 500 | 1.4846 | 0 |
| 550 | 1.4811 | 0 |
| 600 | 1.4785 | 0 |
| 650 | 1.4764 | 0 |
| 700 | 1.4747 | 0 |
| 750 | 1.4733 | 0 |
| 800 | 1.4721 | 0 |

Example 3 is a coated article having an antireflective coating including diamond or diamond material. The coating of Example 3 has a layered structure given by Table 7.

TABLE 7

| Material | Thickness (nm) | Element |
|---|---|---|
| Air | | |
| Al₂O₃ | 80.03 | AR Coating |
| Diamond film | 64.05 | AR Coating |
| Al₂O₃ | 24.88 | AR Coating |
| Diamond film | 18.07 | AR Coating |
| Al₂O₃ | 111.67 | AR Coating |
| Diamond film | 21.57 | AR Coating |
| Al₂O₃ | 34.24 | AR Coating |
| Diamond film | 36.26 | AR Coating |
| Al₂O₃ | 54.20 | AR Coating |
| Diamond film | 9.90 | AR Coating |
| Glass | | Substrate |

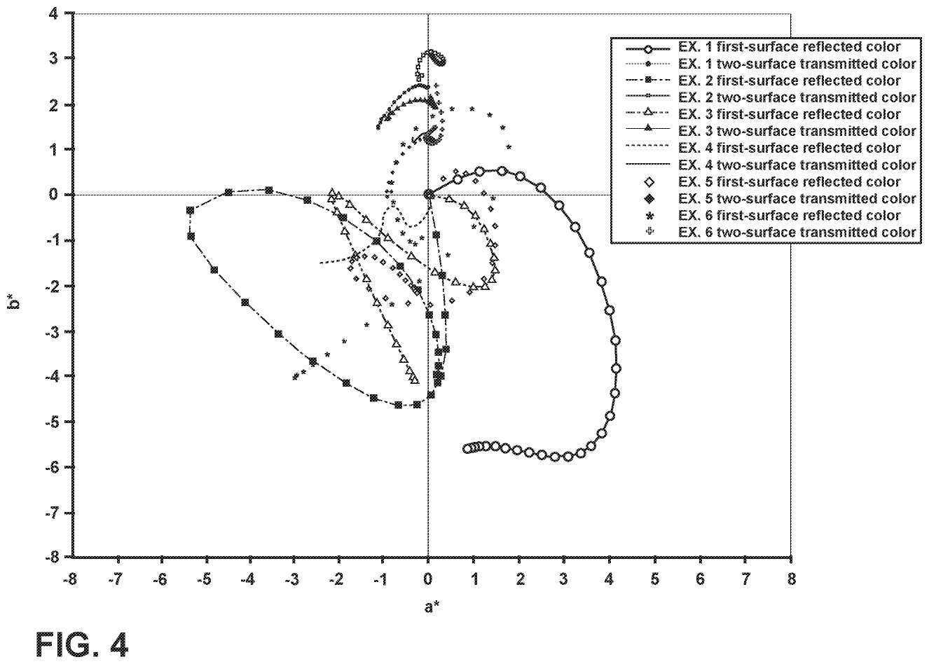

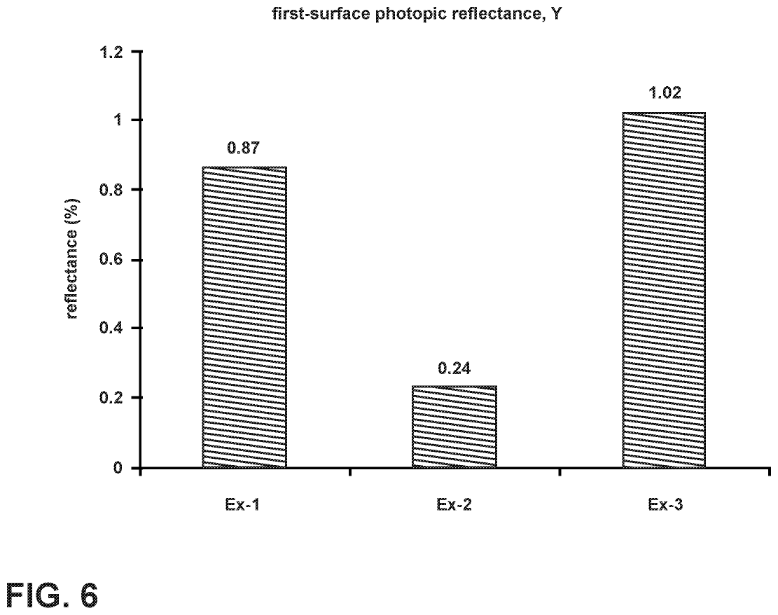

Example 3 has a total thickness of diamond material greater than 149 nm and a lower-index material having a coating material hardness of about 8 GPa or greater, or about 10 GPa or greater. A refractive index of the lower index material may be about 1.5 or greater, or about 1.6 or greater (e.g., Al₂O₃). Example 3 provides for color reduction with a slight increase in reflectance as compared to Example 1. As can be seen in FIG. 6, Example 3 has a first-surface photopic reflectance of 1.02 whereas Example 1 has a first-surface photopic reflectance of 0.87. As can be seen in FIG. 4, the a* and b* values for the first-surface reflected color and two-surface transmitted color are substantially lower for Example 3 as compared to Example 1.

Example 3 has a variety of optical properties. A photopic average reflectance at normal incidence may be about 1.5% or less, or about 1.1% or less. A single-surface reflected a* value may be about 2 or less, or from about −3 to about 2 for all angles of incidence from 0° to 60° or 0° to 90°. A single-surface reflected b* value may be about 1 or less, or about 0.5 or less, or between from about 2 to about −10, or from about 0.5 to about −5 for all angles of incidence between 0° and 60° or 0° and 90°. Example 3 may have a maximum first-surface reflected color shift for any and all viewing angle pairs from about 0° to about 60°, or from about 0° to about 90° of about 5 or less when calculated using Equation (1). Example 3 may have a single-surface or two-surface average photopic transmittance of about 80% or greater, about 90% or greater, or about 94% or greater where the second surface in transmission is a glass surface which reduces transmittance by about 4%. A single-surface or two-surface transmitted color may be from about 3 to about −3 in b* and from about 2 to about −2 in a* for all viewing angles from about 0° to about 60°, or from about 0° to about 90°. Example 3 may have a maximum two-surface transmitted color shift for any and all viewing angle pairs from about 0° to about 60°, or from about 0° to about 84° of about 2 or less, about 1 or less, or about 0.5 or less when calculated using Equation (1). Refractive index values of the materials of Example 3 are provided in Tables 2-4.

Example 4 is a coated article that includes a simple five-layer anti-reflective coating design including diamond and SiO₂. The coating of Example 4 has a layered structure given by Table 8.

TABLE 8

| Material | Thickness (nm) | Element |
|---|---|---|
| Air | | |
| SiO₂ | 81.6 | AR Coating |
| Diamond film | 110.4 | AR Coating |
| SiO₂ | 39.5 | AR Coating |
| Diamond film | 9.3 | AR Coating |
| SiO₂ | 141.2 | AR Coating |
| Glass | | Substrate |

Example 4 has low reflectance and very well controlled color performance. Relative to Example 2, Example 4 has a simpler coating design and a narrower range of reflected color vs. angle, with only a slightly higher photopic average reflectance. For example, Example 4 has a b* value of from about 0 to about −1.7 and an a* value of from about −2.7 to about 0.2 for all angles of incidence from 0° to 60° or 0° to 90°. Such values indicate how similar optical properties may be obtained despite a decrease in the overall number of layers, or scale, of an example.

Example 4 has a variety of optical properties. A photopic average reflectance at normal incidence of may be about 0.5% or less, or about 0.3% or less. As can be seen in FIG. 4, a single-surface reflected a* value may be about 0 or less, or from about −3 to about 0 for all angles of incidence from about 0° to about 60° or about 0° to about 90°. A single-surface reflected b* value may be about 0.5 or less, or about 0 or less, or from about 0.5 to about −2 for all angles of incidence between about 0° and about 60° or about 0° and about 90°. Example 4 may have a maximum first-surface reflected color shift for any and all viewing angle pairs from about 0° to about 60° or about 0° and about 90° of about 3 or less when calculated using Equation (1). Example 4 may have a single-surface or two-surface average photopic transmittance of about 80% or greater, or about 90% or greater, or about 94% or greater, where the second surface in transmission is a glass surface which reduces transmittance by about 4%. A single-surface or two-surface transmitted color may be from about 2 to about 0 in b* and about 1 to about −1 in a* for all viewing angles from about 0° to about 60° or about 0° to about 90°. Example 4 may have a maximum two-surface transmitted color shift for any and all viewing angle pairs from about 0° to about 60° or about 0° to about 84° of about 2 or less, or about 1 or less, or about 0.5 or less when calculated using Equation (1). Refractive index values of the materials of Example 4 are provided in Tables 2, 4, and 6.

Coating examples using three or more materials are also within the scope of this disclosure. For example, an anti-reflective coating that includes diamond film, Al₂O₃, TiO₂, and/or SiO₂ may be advantageous in combining low reflectance and high durability. Examples 5 and 6 illustrate anti-reflective coating designs for coated articles. The coatings of Examples 5 and 6 have a layered structure given by Tables 9 and 10 respectively.

TABLE 9

| Material | Thickness (nm) | Element |
|---|---|---|
| Air | | |
| Al₂O₃ | 76.8 | AR Coating |
| Diamond film | 41.7 | AR Coating |
| TiO₂-anatase | 7.7 | Seeding Layer |
| Al₂O₃ | 27.3 | AR Coating |
| Diamond film | 13.9 | AR Coating |
| TiO₂-anatase | 3.91 | Seeding Layer |
| Al₂O₃ | 122.3 | AR Coating |
| Diamond film | 10.1 | AR Coating |
| TiO₂-anatase | 13.86 | Seeding Layer |
| Al₂O₃ | 40.6 | AR Coating |
| Diamond film | 15.1 | AR Coating |
| TiO₂-anatase | 7.7 | Seeding Layer |
| Al₂O₃ | 60.9 | AR Coating |
| TiO₂-anatase | 4.8 | Seeding Layer |
| Glass | | Substrate |

TABLE 10

| Material | Thickness (nm) | Element |
|---|---|---|
| Air | | |
| Al₂O₃ | 80.5 | AR Coating |
| Diamond film | 17.45 | AR Coating |
| TiO₂-anatase | 9.9 | Seeding Layer |
| Diamond film | 77.7 | AR Coating |
| TiO₂-anatase | 5.4 | Seeding Layer |
| Al₂O₃ | 52.7 | AR Coating |
| TiO₂-anatase | 12 | Seeding Layer |
| Al₂O₃ | 58.5 | AR Coating |
| Diamond film | 14.7 | AR Coating |
| TiO₂-anatase | 6 | Seeding Layer |
| Al₂O₃ | 54.95 | AR Coating |
| TiO₂-anatase | 7.11 | Seeding Layer |
| Sapphire | | Substrate |

Examples 5 and 6 incorporate thin TiO₂ (anatase) seeding layers (e.g., the seed layer 22) for each diamond film layer. The amount, or thickness, of TiO₂ is small relative to the amount of hard diamond and hard Al₂O₃ materials. As with the other examples, the coatings of Examples 5 and 6 are compatible with chemically strengthenable glass substrates and single-crystal Al₂O₃ (e.g., sapphire) substrates. These different substrates have different refractive indices, requiring different optimal coating designs. The use of TiO₂ seed layers may be preferred in cases where a highly crystalline diamond layer is desired for maximization of hardness, maximization of refractive index, and/or minimization of optical absorption, and where it is too costly or impractical to use other diamond-seeding approaches at multiple layers within the stack (such as surface roughening, coating, abrasion, or ultrasonication with dispersed diamond nanocrystals). Refractive index values of the materials of Examples 5 and 6 are provided in Tables 2, 4, 6, 11 and 12. As can be seen from FIGS. 3-5, the addition of the seeding layers does not have an appreciable effect on the optical properties of the examples, while imparting a greater strength to the coatings disposed thereon.

TABLE 11
Sapphire substrate refractive index.
Sapphire substrate

| Wavelength (nm) | n | k |
|---|---|---|
| 400.0 | 1.7862 | 0 |
| 442.8 | 1.7802 | 0 |
| 459.2 | 1.7784 | 0 |
| 495.9 | 1.7750 | 0 |
| 516.6 | 1.7734 | 0 |
| 539.1 | 1.7717 | 0 |
| 563.6 | 1.7701 | 0 |
| 590.4 | 1.7686 | 0 |
| 619.9 | 1.7670 | 0 |
| 652.6 | 1.7654 | 0 |
| 688.8 | 1.7638 | 0 |
| 729.3 | 1.7622 | 0 |
| 774.9 | 1.7606 | 0 |
| 826.6 | 1.7590 | 0 |

TABLE 12
TiO₂ film refractive index.
TiO₂ (anatase) film

| Wavelength (nm) | n | k |
|---|---|---|
| 391.2 | 3.32 | 0 |
| 403.9 | 3.24 | 0 |
| 421.8 | 3.16 | 0 |
| 442.9 | 3.1 | 0 |
| 466.2 | 3.04 | 0 |
| 496 | 2.98 | 0 |
| 534.5 | 2.94 | 0 |
| 579.4 | 2.89 | 0 |
| 635.9 | 2.85 | 0 |
| 704.5 | 2.82 | 0 |
| 800 | 2.8 | 0 |

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

What is claimed is:

1. An article comprising:
a glass-based substrate comprising a primary surface; and
an optical film disposed on the primary surface and comprising:
a first plurality of layers comprising one or more of diamond, a diamond film, diamond-containing material, diamond-like carbon and amorphous carbon; and
a second plurality of layers, each layer of the second plurality of layers arranged in an alternating manner with each layer of the first plurality of layers,
wherein the optical film comprises an average photopic light reflection of about 2.0% or less and a transmittance of about 85% or greater over the wavelength range of from about 500 nm to about 800 nm.

2. The article of claim 1, wherein one or more layers of the first plurality of layers comprises a thickness of about 50 nm or greater.

3. The article of claim 1, wherein the first plurality of layers comprises a total thickness of about 30% or greater of a total thickness of the optical film.

4. The article of claim 1, wherein the first plurality of layers comprises a total thickness of about 40% or greater of a total thickness of the optical film.

5. The article of claim 1, wherein one or more layers of the second plurality of layers comprises a thickness of about 10 nm or greater and comprises one or more of Al₂O₃, SiO₂, SiOxNy, SiNₓ and SiAlON.

6. The article of claim 1, further comprising:
a seed layer positioned between one or more of the first and second layers, wherein the seed layer comprises a diamond-nucleating material.

7. The article of claim 6, wherein the seed layer comprises a thickness between about 1 nm and about 10 nm.

8. The article of claim 1, wherein an sp3/sp2 bond ratio of each layer of the first plurality of layers is about 50% or greater.

9. The article of claim 1, wherein a total number of the layers of the first and second plurality of layers is about 20 or less.

10. The article of claim 1, wherein each layer of the second plurality of layers comprises a refractive index of about 1.45 or greater at a wavelength of 550 nm.

11. The article of claim 10, wherein each layer of the first plurality of layers comprises a refractive index of about 2.0 or greater at a wavelength of 550 nm.

12. The article of claim 1, wherein the optical film comprises a single-surface average photopic light reflection of about 0.5% or less.

13. The article of claim 1, wherein the article comprises or is characterized by a color shift of about 5 or less, when viewed at an incident illumination angle in the range from about 20 degrees to about 60 degrees from normal incidence, wherein the color shift is given by √((a*₂−a*₁)²+(b*₂−b*₁)²), where a*₁ and b*₁ are color coordinates of the article when viewed at normal incidence and a*₂, and b*₂ are color coordinates of the article viewed at the incident illumination angle, and further wherein the color coordinates of the article when viewed at normal incidence and at the incident illumination angle are both in transmission or reflection.

14. An article comprising:
a substrate comprising a glass, glass-ceramic, or ceramic composition and a primary surface; and
an optical film disposed on the primary surface and comprising:
a first plurality of layers comprising diamond or diamond-like carbon; and
a second plurality of layers, each layer of the second plurality of layers arranged in an alternating manner with each layer of the first plurality of layers,
wherein the optical film comprises an average photopic light reflection of about 2.0% or less and a transmittance of about 85% or greater from about 500 nm to about 800 nm,
further wherein greater than 50% of the layers of the first and second plurality of layers each comprises a refractive index of about 1.6 or greater at 550 nm wavelength.

15. The article of claim 14, wherein the optical film comprises a photopic transmittance of about 90% or greater.

16. The article of claim 14, wherein the substrate comprises a glass selected from the group consisting of soda lime glass, alkali aluminosilicate glass, alkali containing borosilicate glass and alkali aluminoborosilicate glass.

17. The article of claim 14, wherein the article comprises or is characterized by a color shift of about 5 or less, when viewed at an incident illumination angle in the range from about 20 degrees to about 60 degrees from normal incidence, wherein the color shift is given by √((a*₂−a*₁)²+(b*₂−b*₁)²), where a*₁ and b*₁ are color coordinates of the article when viewed at normal incidence and a*₂, and b*₂ are color coordinates of the article viewed at the incident illumination angle, and further wherein the color coordinates of the article when viewed at normal incidence and at the incident illumination angle are both in transmission or reflection.

18. The article of claim 14, wherein each layer of the second plurality of layers comprises a refractive index of about 1.6 or greater at a wavelength of 550 nm.

19. The article of claim 18, wherein each layer of the first plurality of layers comprises a refractive index of about 2.0 or greater at a wavelength of 550 nm.

20. (canceled)

21. A method of forming an optical film, comprising the steps:
depositing a plurality of first layer layers comprising diamond or diamond-like carbon on a primary surface of a glass-based substrate; and
depositing a second plurality of layers arranged in an alternating manner with each layer of the first plurality of layers such that the optical film comprises an average photopic light reflection of about 2.0% or less and a transmittance of about 85% or greater over the wavelength range of from about 500 nm to about 800 nm.

22-25. (canceled)
